(19) United States
(12) Patent Application Publication
(10) Pub. No.: US 2025/0128688 A1
(43) Pub. Date: Apr. 24, 2025

(54) Brake System for a Vehicle

(71) Applicant: Robert Bosch GmbH, Stuttgart (DE)

(72) Inventors: Armin Frueh, Bietigheim-Bissingen (DE); Frank Baehrle-Miller, Schoenaich (DE); Matthias Vieth, Besigheim (DE); Otmar Bussmann, Abstatt (DE); Tobias Putzer, Flein (DE)

(21) Appl. No.: 18/901,803

(22) Filed: Sep. 30, 2024

(30) Foreign Application Priority Data
Oct. 18, 2023 (DE) 10 2023 210 228.5

(51) Int. Cl. B60T 13/68; B60T 7/04; B60T 8/40; B60T 13/14; B60T 13/58; B60T 13/62

(52) U.S. Cl. CPC B60T 13/686; B60T 7/042; B60T 13/148; B60T 13/588; B60T 13/62; B60T 8/4081; B60T 13/142; B60T 2220/04; B60T 2270/402; B60T 2270/404; B60T 2270/82

(57) ABSTRACT

A brake system for a vehicle comprising brakes respectively associated with two axles of the vehicle, wherein the brake system is actuated by means of a primary controller and a secondary controller. The system is configured such that in the event of an error of the primary controller, the supply of a hydraulic fluid to brakes of one of the axles is interrupted. A method for operating such a brake system, a computer program product for carrying out the method, and a vehicle having such a brake system is described.

This application claims priority under 35 U.S.C. § 119 to application no. DE 10 2023 210 228.5, filed on Oct. 18, 2023 in Germany, the disclosure of which is incorporated herein by reference in its entirety.

The present disclosure relates to a brake system for a vehicle, comprising brakes associated with each of two axles of the vehicle. The disclosure further relates to a method for operating such a brake system. The disclosure further relates to a computer program product for carrying out the method. Finally, the disclosure relates to a vehicle having such a brake system.

### BACKGROUND

A brake system comprising brakes associated with different axles of the vehicle is typically used to brake a vehicle. Typically, one such brake of the brake system is associated with each of the wheel of an axle of the vehicle. When a brake pedal of a brake pedal device is actuated, a simulator device is used to impart a feeling of braking to a vehicle operator. In fact, the braking operation is performed via an electromotive actuator in a circuit in which the brakes are integrated, said actuator generating a hydraulic pressure as a function of the displacement of the brake pedal. Thus, the braking effect is generally also amplified.

The actuation of such a brake system is typically carried out by at least one controller. In the event of an error, the brake pedal device is typically directly connected to the circuit, such that the vehicle operator directly produces hydraulic pressure in the circuit for braking via the brake pedal without amplification.

### SUMMARY

An object of the present disclosure is to provide improved or at least other embodiments for a brake system of the above type, for a method for operating such a brake system, for a computer program product for carrying out the method, and for a vehicle having such a brake system. In particular, an object of the present disclosure is to disclose embodiments characterized by improved braking effect in the event of an error for the brake system, for the method, for the computer program product, and for the vehicle.

The object is achieved according to the disclosure by the subject-matter of the disclosure. Advantageous embodiments are the subject-matter of the disclosure.

The object is achieved according to the disclosure in that, for a vehicle having brakes associated with two axles of the vehicle, supplying a hydraulic fluid to brakes of one of the axles in a brake system is prevented in case of an error. As a result, the unamplified and direct actuation of the brakes via a brake pedal device of the brake system in the event of an error requires a smaller displacement of a brake pedal of the brake pedal device by a vehicle operator. The insight that pedal feel and thus braking feel and the braking effect significantly change in the event of an error is applied here. In particular, the brake pedal feels “softer” for the vehicle operator, i.e. has lower resistance, and the vehicle operator must displace the brake pedal further for a comparable braking effect than in the error-free case in which amplification takes place. In addition, in the event of an error, a lesser delay occurs before achieving the braking effect due to the direct action. Overall, in this manner, the vehicle operator experiences severe confusion when the error occurs, which in turn can lead to a ultimately low braking effect actually being achieved. According to the present disclosure, said effect is thus counteracted by the aforementioned disconnecting of the brakes of one axle from a fluid column of the hydraulic fluid between the brake pedal device and the brakes. This has the immediate consequence that the resistance in the fluid column increases and more hydraulic pressure is available for the brakes of the other axle to brake. In combination, the result is a better braking feel for the vehicle operator as well as an improved braking effect.

According to the disclosure, the brake system for a first axle of the vehicle comprises two brakes, also hereinafter referred to as first axle brakes. The first axle has two wheels, subsequently also referred to as first axle wheels. That is, the brake system comprises two first axle brakes, one for each first axle wheel of the first axle of the vehicle. In addition, the brake system comprises two brakes for a second axle of the vehicle, also hereinafter referred to as second axle brakes. The second axle has two wheels, subsequently also referred to as second axle wheels. That is, the brake system comprises two second axle brakes, one for each second axle wheel of the second axle of the vehicle. The brake system also comprises a circuit for providing the hydraulic fluid to the brakes. In the circuit, the brake system for the respective first axle brake comprises an associated first axle inlet valve for admitting the hydraulic fluid to the associated first axle brake and an associated first axle outlet valve for discharging the hydraulic fluid from the associated first axle brake. In the circuit for the respective second axle brake, the brake system further comprises an associated second axle inlet valve for admitting the hydraulic fluid to the associated second axle brake and an associated second axle outlet valve for discharging the hydraulic fluid from the associated second axle brake. The respective inlet valve is open when de-energized. That is, the respective inlet valve is open without further actuation, such that hydraulic fluid can flow to the associated brake. In addition, the respective outlet valve is closed when de-energized. That is, the respective outlet valve is closed without further actuation, such that a flow of the hydraulic fluid from the associated brake is blocked. The brake pedal device is disposed outside of the circuit and serves for actuating the brakes. The brake pedal device can be connected to the circuit via at least one valve, is also hereinafter referred to as the circuit valve. The brake system further comprises a sensor device for determining a displacement of the brake pedal of the brake pedal device. The sensor device is thus configured to determine the displacement during operation. The brake system also comprises an electromotive actuator for providing a hydraulic pressure of the hydraulic fluid in the circuit during operation. Said amplification thus takes place by means of the electromotive actuator. The brake system comprises two controllers for operating the brake system, also hereinafter referred to as a primary controller and a secondary controller. The primary controller is connected to the first axle inlet valves and the first axle outlet valves such that, during operation, the primary controller actuates the first axle inlet valves and the first axle outlet valves. The primary controller is also connected to the sensor device and the electromotive actuator such that the primary controller provides, by means of the electromotive actuator, a hydraulic pressure in the circuit as a function of the displacement. The secondary controller is connected to the second axle inlet valves and the second axle outlet valves such that, during operation, the secondary controller actuates the second axle inlet valves and the second axle outlet valves. The brake system is configured such that, in an error-free state of at least the primary controller, the brake pedal device is hydraulically separated from the circuit so that the hydraulic pressure is provided by means of the electromotive actuator as a function of the displacement in the circuit. In addition, the brake system is configured such that, in the event of an error of the primary controller, the brake pedal device is hydraulically connected to the circuit such that the brake pedal directly displaces hydraulic fluid in the circuit and thus provides hydraulic pressure in the circuit. In addition, the secondary controller closes the second axle inlet valves such that the hydraulic pressure in the circuit is supplied to the first axle brakes.

In the event of an error of the primary controller, actuation of the electromotive actuator connected to the primary controller, hereinafter also referred to briefly as the actuator, does not occur. Thus, there is an unamplified hydraulic engagement by means of the brake pedal device. Due to the closed second axle inlet valves, there is a significant improvement in the pedal feel for the vehicle operator and an improved braking effect via the first axle brakes.

The brake system advantageously comprises a simulator device connected to the brake pedal device via an associated valve, the valve also hereinafter being referred to as a simulator shutoff valve. The simulator device is configured to provide, during operation, a resistance in the brake pedal device, the resistance being advantageously as a function of the displacement of the brake pedal. Preferably, the simulator device in the brake pedal device displaces hydraulic fluid to impart a sense of braking to the vehicle operator.

In advantageous embodiments, the primary controller is separate from the second axle inlet valves and the second axle outlet valves, so that said controller cannot actuate said valves, at least not directly.

The actuation of the electromotive actuator as well as all valves except the second axle inlet valves and the second axle outlet valves is preferably carried out by the primary controller.

In preferred embodiments, the secondary controller is separated from the first axle inlet valves and the first axle outlet valves.

When no error is present, the brake system is fully operational.

If there is a secondary controller error, the second axle inlet valves are open because said valves are normally open when de-energized. In addition, the second axle outlet valves are closed as said valves are normally closed when de-energized. Thus, by means of the primary controller, the first axle brakes can be actuated regularly by means of the actuator as well as the first axle inlet valves and first axle outlet valves. Thus, the two first axle brakes are fully available for braking and, in particular, also for road handling control.

The respective controller is advantageously a control unit or a control device.

The respective controller may in principle be configured arbitrarily.

For example, the respective controller may be a control device. In particular, the primary controller may be an ESP control device or may be part of an ESP control device.

It is also conceivable that the primary controller and the secondary controller are implemented within the same control device.

Preferably, when no error is present, the actuation of the inlet valves and outlet valves in the primary controller is calculated, and is communicated to the secondary controller.

In so doing, the secondary controller may itself determine/calculate the corresponding actuation of the second axle inlet valves and the second axle outlet valves.

Likewise, when no error is present, the calculation of the actuations can take place entirely in the primary controller, wherein only the result of the valve actuation of the second axle inlet valves and the second axle outlet valves is transmitted to the secondary controller. This results in a reduction in internal communication between the controllers.

Variants in which the brake system is further configured to close the simulator shutoff valve upon error of the primary controller are deemed advantageous. As a result, the simulator device is disconnected from the brake pedal. In this way, no simulated resistance in the brake pedal device is carried out as a function the displacement. This leads to a further improvement of pedal feel for the vehicle operator as well as of the braking effect.

In preferred embodiments, at least one parking brake actuator of the brake system may be used in case of error of the primary control instance to also achieve a braking effect on the second axle brakes and/or to increase the braking effect on the first axle brakes. That is to say that the brake system preferably comprises a parking brake actuator for at least one of the wheels, in particular for at least one of the second axle wheels. The brake system is configured in such a way that at least one of the at least one parking brake actuators is actuated as a function of the displacement of the brake pedal in the event of an error of the primary controller.

The respective parking brake actuator is preferably electrical. That is, the particular parking brake actuator is preferably an electric parking brake actuator.

The at least one parking brake actuator may be used, for example, such that a braking effect or deceleration of 1.5 m/s² occurs.

Preferably, the brake system for at least one of the second axle brakes comprises such a parking brake actuator, wherein, in the event of an error of the primary controller, actuation of the parking brake actuator is a function of the displacement of the brake pedal.

Preferably, at least one of the at least one parking brake actuators is actuated only when the displacement of the brake pedal exceeds a specified limit value. The brake system is configured accordingly. That is, when the limit value is exceeded, the at least one parking brake actuator provides a predefined braking force.

Preferably, at least one of the at least one parking brake actuators, preferably the respective parking brake actuator, of the second axle brakes initially approaches an associated brake piston when the displacement of the brake pedal exceeds a threshold value, that is, the free travel is eliminated. The threshold value is less than the limit value. Upon further increase in the displacement of the brake pedal, the proportion of force from the parking brake actuator is then increased accordingly.

A maximum force of the at least one parking brake actuator is preferably set such that said force does not result in locking up of the associated wheel. In other words, the maximum force is limited to a value less than the lock-up force.

A reduction of the braking request by the vehicle operator, i.e. a reduction of the displacement of the brake pedal, advantageously leads to a corresponding reduction of the braking force generated by the at least one parking brake actuator.

Advantageously, actuation of at least one of the at least one parking brake actuators is stepped as a function of the displacement of the brake pedal. Thus, there is an improved braking effect.

It is understood that, in addition to the brake system, a vehicle having the brake system is also within the scope of this disclosure. The respective axle comprises two wheels, the first axle thus two first axle wheels and the second axle two second axle wheels.

Preferably, the first axle is a front axle and the second axle is a rear axle of the vehicle. In particular, this has the advantage that in the event of an error of the primary controller, despite the unamplified actuation of the first axle brakes and thus the front-axle brakes, some road handling control is still possible.

It is further understood that, in addition to the brake system and the vehicle, a method for operating the brake system is also within the scope of this disclosure.

In the method, therefore, when the primary controller and the secondary controller are in an error-free state, the brake pedal device is hydraulically separated from the circuit and the hydraulic pressure in the circuit is provided by means of the actuator as a function of the displacement. In addition, in the event of an error of the primary controller, the brake pedal device is hydraulically connected to the circuit and the supply of the hydraulic fluid to the second axle brakes is shut off so that the brake pedal device directly provides the hydraulic pressure in the circuit and the hydraulic pressure is supplied to the first axle brakes.

In addition, preferably at least one of the at least one parking brake actuators is actuated as described, as a function of the displacement of the brake pedal.

The operation of the brake system, in particular the method, is preferably implemented by means of a computer program product stored, for example, at least partially in the brake system and/or at least partially in the vehicle.

The computer program product comprises instructions for operating the brake system as described when the computer program product is executed by the brake system.

Further important features and advantages of the disclosure will emerge from the disclosure, from the drawings, and from the associated figure description with reference to the drawings.

It is understood that the features specified hereinabove and those yet to be explained hereinafter can be used not only in the combination indicated in each case, but also in other combinations or on their own, without departing from the scope of the present disclosure.

Preferred exemplary embodiments of the disclosure are shown in the drawings and are explained in more detail in the following description, wherein the same reference numbers refer to the same or similar or functionally identical components.

### BRIEF DESCRIPTION OF THE DRAWINGS

Schematically shown are:

FIG. 1 a highly simplified schematic representation of a brake system of a vehicle in an error-free state,

FIG. 2 a highly simplified schematic representation of the brake system in a different state.

### DETAILED DESCRIPTION

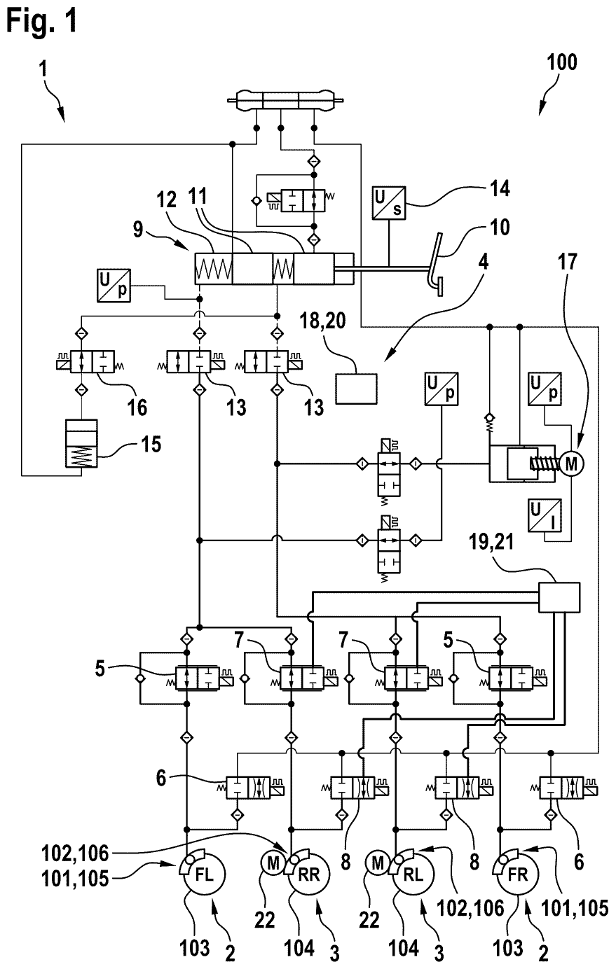

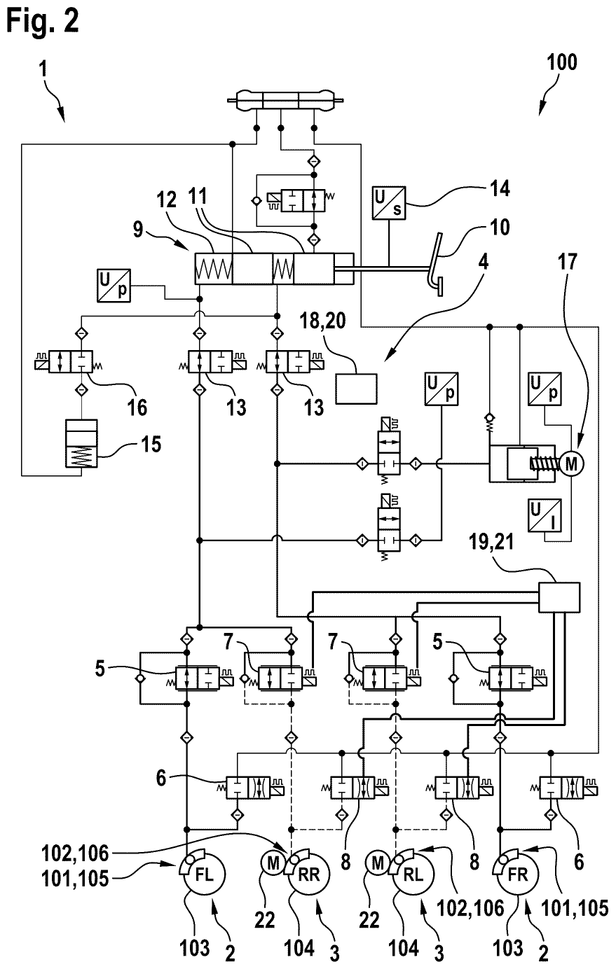

An exemplary brake system 1 shown in the figures is used in a vehicle 100. The brake system 1 comprises two brakes 2, 3, for each of a first axle 101 and a second axle 102 of the vehicle 100. The brakes 2 for the first axle 101 are also hereinafter referred to as first axle brakes 2 and the brakes 3 for the second axle 102 are also referred to as second axle brakes 3. The respective brake 2, 3 is associated with an associated wheel 103, 104, not shown here, of the associated axle 101, 102. The wheels 103 of the first axle 101 are also hereinafter referred to as first axle wheels 103 and the wheels 104 of the second axle 102 are also hereinafter referred to as second axle wheels 104. In the exemplary embodiment shown, the first axle 101 is a front axle 105 and the second axle 102 is a rear axle 106 of the vehicle 100. The brake system 1 thus comprises two first axle brakes 2 for each of a first axle wheel 103 of the first axle 101 and two second axle brakes 3 for each of a second axle wheel 104 of the second axle 102. The brake system 1 also comprises a circuit 4 for providing a hydraulic fluid and thus a hydraulic pressure on the brakes 2, 3. The brakes 2, 3 are thus braked by means of the hydraulic pressure. In the circuit 4, the brake system 1 for the respective first axle brake 2 comprises an associated inlet valve 5 for admitting the hydraulic fluid to the associated first axle brake 2 and an outlet valve 6 for discharging the hydraulic fluid from the associated first axle brake 2. The respective inlet valve 5 is hereinafter also referred to as the first axle inlet valve 5 and the respective outlet valve 6 is also referred to as the first axle outlet valve 6. Analogously, in the circuit 4 for the respective second axle brake 2, the brake system 1 comprises an associated inlet valve 7 for admitting the hydraulic fluid to the associated second axle brake 3 and an outlet valve 8 for discharging the hydraulic fluid from the associated second axle brake 3. The respective inlet valve 7 is hereinafter also referred to as the second axle inlet valve 7 and the respective outlet valve 8 is hereinafter also referred to as the second axle outlet valve 8. The respective inlet valve 5, 7 is open when de-energized, as indicated in the figures by an otherwise unlabeled spring. That is, 13ompristive inlet valve 5, 7 enables admitting the hydraulic fluid into the associated brake 2, 3 without further actuation. In contrast, the respective outlet valve 6, 8 is closed when de-energized, as also indicated in the figures by an otherwise unlabeled spring. That is, the respective outlet valve 6, 8 blocks a flow of the hydraulic fluid from the associated brake 2, 3 without further control. Outside of the circuit 4, the brake system comprises a brake pedal device 9 for actuating the brakes 2, 3,13ompriseng a brake pedal 10. By actuating the brake pedal 10, i.e. by displacing the brake pedal 10, usually by a vehicle operator, hydraulic fluid is displaced by means of a piston 11 within a cylinder 12 of the brake pedal device 9 as indicated in the figures. The brake pedal device 9 can be connected to the circuit 4 via at least one valve 13, also hereinafter referred to as the circuit valve 13. When the at least one circuit valve 13 is closed (see FIG. 1), the brake pedal device 9 is hydraulically separated from the circuit 4. When the at least one circuit valve 13 is open (see FIG. 2), the brake pedal device 9 is hydraulically connected to the circuit 4. The brake system 1 comprises a sensor device 14 for determining a displacement of the brake pedal 10. In the exemplary embodiments shown, the brake system 1 also comprises a simulator device 15. The simulator device 15 is hydraulically connected to the brake pedal device 9 via a valve 16, also hereinafter referred to as the simulator shutoff valve 16. During operation, the simulator device 15 provides a resistance as a function of the displacement of the brake pedal in the brake pedal device 9. This is done in the exemplary embodiments shown in that the simulator device 15 displaces hydraulic fluid in the brake pedal device 9. An electric motor actuator 17 of the brake system 1 is used to establish a hydraulic pressure in the circuit 4. This is done as a function of the displacement. The electromotive actuator 17 is also be referred to hereinafter briefly as the actuator 17.

The system 1 comprises two controllers 18, 19, hereinafter also referred to as controllers 18, 19, for actuating the brake system 1. One of the controllers 18 is also hereinafter referred to as the primary controller 18 and the other controller 19 is referred to as the secondary controller 19. In the exemplary embodiment shown, the controllers 18, 19 are implemented purely by way of example in respective associated control devices 20, 21. The primary controller 18 is connected (not shown) to the first axle inlet valves 5, the first axle outlet valves 6, and to the actuator 17, such that said components can be actuated by the primary controller 18. In contrast, in the exemplary embodiments shown, the primary controller 18 is separated from the second axle inlet valves 7 and the second axle outlet valves 8. The primary controller 18 is also connected (not shown) to the sensor device 14, such that the primary controller 18 provides a hydraulic pressure in the circuit 4 by means of the actuator 17 as a function of the displacement. The secondary controller 19 is connected to the second axle inlet valves 7 such that, during operation, the secondary controller 19 can actuate the second axle inlet valves 7. In addition, in the exemplary embodiment shown, the secondary controller 19 is connected to the second axle outlet valves 8 so that the secondary controller 19 can actuate the second axle outlet valves 8 during operation. In the exemplary embodiment shown, the secondary controller 19 is separated from the first axle Inlet valves 5 and the second axle outlet valve 6.

FIG. 1 shows the operation of the brake system 1 in a so-called “full system”, i.e. when the controllers 18, 19 are error-free. In said error-free state, the brake pedal device 9 is hydraulically separated from the circuit 4, i.e. the at least one circuit valve 13 is closed. Thus, there is no direct fluid connection between the brake pedal device 9 and the circuit 4, as indicated in FIG. 1 by dashed lines between the brake pedal device 9 and the circuit 4. Thus, in an error-free state, there is no hydraulic fluid column between the brake pedal device 9 and the brakes 2, 3. In the error-free state, the actuation of the brakes 2, 3 is carried out by means of the hydraulic pressure in the circuit 4 provided by means of the actuator 17 as a function of the displacement of the brake pedal 10. That is, in the error-free state, amplification is accomplished by means of the actuator 17. Simultaneously, in the exemplary embodiment shown, the simulator device 15 simulates to a vehicle operator that a corresponding braking operation takes place by means of resistance in the brake pedal device 9.

In a state indicated in FIG. 2, in contrast, wherein the primary controller 18 has an error, in particular is out of service, the brake pedal device 9 is hydraulically connected to the circuit 4, that is, the circuit valve 13 is open. Thus, said fluid column is produced. As a result, the brake pedal 9 directly displaces hydraulic fluid in the circuit 4 and consequently establishes hydraulic pressure in the circuit 4 for the braking operation. In addition, the secondary controller 19 closes the second axle inlet valves 7 such that the hydraulic pressure in the circuit 4 is supplied to the first axle brakes 2 but not the second axle brakes 3.

In the exemplary embodiment shown, the secondary controller 19 is separated from the first axle inlet valves 5 and the first axle outlet valves 6.

In the exemplary embodiment shown, in the event of an error of the primary controller 18, the simulator shutoff valve 16 is closed, such that the simulator device 15 is separated from the brake pedal device 9.

As can be seen in the figures, in the exemplary embodiments shown, each second axle brake 3 is also associated with an electrical actuator 22 of a parking brake function of the brake system 1, also subsequently referred to as a parking brake actuator 22. In the event of an error of the first primary controller 18, i.e., when the second axle inlet valves 7 are also closed, a braking effect is also generated as needed by means of the parking brake actuators 22 on the second axle brakes 3 and thus on the second axle wheels 104. In the exemplary embodiment shown, this occurs as a function of the displacement of the brake pedal 10. In so doing, preferably when a threshold value of the displacement is exceeded, the parking brake actuator 22 is initially driven to an associated brake piston, not shown, of the associated second axle brake 3, so that the free travel is eliminated. When the displacement exceeds a limit value greater than the threshold value, the associated second axle brake 3 is actuated by means of the associated parking brake actuator 22. In so doing, the braking force imparted by means of the parking brake actuator 22 is always less than the force leading to locking up of the associated second axle wheel 104. The actuation of the respective parking brake actuator 22 is preferably performed as a function of the displacement when the limit value is exceeded.

To implement operation, the parking brake system 1 is configured accordingly. In particular, the controllers 18, 19 and/or the control devices 20, 21 are configured accordingly. A corresponding computer program product may be used for this purpose, for example. Thus, the computer program product comprises instructions that, when executed by the brake system 1, cause the brake system 1 to operate as described.

What is claimed is:

1. A brake system for a vehicle, comprising:
two first axle brakes for respective first axle wheels of a first axle of the vehicle;
two second axle brakes for respective second axle wheels of a second axle of the vehicle;
a circuit configured to provide a hydraulic fluid to the two first axle brakes and the two second axle brakes, wherein
the circuit comprises an associated first axle inlet valve configured to admit the hydraulic fluid, and an associated first axle outlet valve configured to discharge the hydraulic fluid, for each of the two first axle brakes,
the circuit comprises an associated second axle inlet valve configured to admit the hydraulic fluid, and an associated second axle outlet valve configured to discharge the hydraulic fluid, for each of the two second axle brakes,
the associated first axle inlet valves and the associated second axle inlet valves are configured to be open when de-energized, and
the associated first axle outlet valves and the associated second axle outlet valves are configured to be closed when de-energized;
a brake pedal device disposed outside the circuit and configured to actuate the two first axle brakes and the two second axle brakes, the brake pedal device configured to be connected to the circuit via at least one circuit valve;
a sensor device configured to provide a signal for determining a displacement of a brake pedal of the brake pedal device;
an electromotive actuator configured to provide a hydraulic pressure during operation in the circuit;
a primary controller operably connected to the first axle inlet valves and first axle outlet valves, such that, during operation, the primary controller actuates the first axle inlet valves and the first axle outlet valves, wherein the primary controller is connected to the sensor device and the electromotive actuator, such that the primary controller provides, using the actuator, a hydraulic pressure in the circuit as a function of the determined displacement; and
a secondary controller operably connected to the second axle inlet valves such that, during operation, the secondary controller actuates the second axle inlet valves, wherein
the brake system is configured such that, in an error-free state of at least the primary controller, the brake pedal device is hydraulically separated from the circuit so that the hydraulic pressure is provided in the circuit by the actuator as a function of the determined displacement, and
the brake system is configured such that,
in response to an error of the primary controller the brake pedal device is connected to the circuit such that the brake pedal displaces hydraulic fluid in the circuit in response to actuation and thus provides a hydraulic pressure in the circuit, and such that
in response to the error of the primary controller the secondary controller closes the second axle inlet valves such that the hydraulic pressure in the circuit is supplied to the first axle brakes.

2. The brake system according to claim 1, wherein the brake system is configured to close a simulator shutoff valve in response to the error of the primary controller such that a simulator device is separated from the brake pedal device.

3. The brake system according to claim 1, wherein:
the brake system further comprises an electric parking brake actuator for a second axle brake; and
the brake system is configured such that, in response to the error of the primary controller, the electric parking brake actuator is actuated as a function of the determined displacement.

4. The brake system according to claim 3, wherein the brake system is configured such that the electric parking brake actuator is actuated only when the determined displacement of the brake pedal exceeds a specified limit value.

5. The brake system according to claim 3, wherein the actuation of the electric parking brake actuator is stepped as a function of the determined displacement.

6. A method for operating the brake system according to claim 1, comprising:
providing the hydraulic pressure in the circuit using the electromechanical actuator as a function of the determined displacement, in the error-free state of at least the primary controller which includes an error-free state of the secondary controller, wherein the brake pedal device is hydraulically separated from the circuit; and
in response to an error of the primary controller, hydraulically connecting the brake pedal device to the circuit and separating supply of the hydraulic fluid from the second axle brakes such that the brake pedal device directly provides hydraulic pressure in the circuit and the hydraulic pressure is supplied to the first axle brakes.

7. The method according to claim 6, wherein:
the brake system further comprises an electric parking brake actuator for a second axle brake;
the brake system is configured such that, in response to the error of the primary controller, the electric parking brake actuator is actuated as a function of the determined displacement; and
the method includes actuating the electric parking brake actuator, in response to an error of the primary controller, as a function of the determined displacement.

8. A computer program product comprising instructions configured to operate the brake system according to the method of claim 6 when executed by the brake system.

9. A vehicle with the brake system of claim 1, the vehicle including:
the first axle comprising the two first axle wheels; and
the second axle comprising the two second axle wheels.

10. The vehicle according to claim 9, wherein:
the first axle is a front axle of the vehicle; and
the second axle is a rear axle of the vehicle.
